(19) United States
(12) Patent Application Publication
(10) Pub. No.: US 2026/0244511 A1
(43) Pub. Date: Aug. 20, 2026

(54) DYNAMIC RESOURCE ALLOCATION FOR CONNECTED VEHICLES

(71) Applicant: GM GLOBAL TECHNOLOGY OPERATIONS LLC, Detroit, MI (US)

(72) Inventor: Wenyuan QI, Shanghai (CN)

(21) Appl. No.: 19/446,732

(22) Filed: Jan. 12, 2026

(30) Foreign Application Priority Data
Feb. 18, 2025 (CN) 2025101822410

(51) Int. Cl. G06F 9/50; H04W 4/38; H04W 4/44; B60W 60/00

(52) U.S. Cl. CPC G06F 9/5072; H04W 4/38; H04W 4/44; B60W 60/001

(57) ABSTRACT

An example dynamic resource allocation system for vehicles includes a first second vehicles located in different geographic regions, each including a corresponding vehicle control module, wireless interface and multiple sensors, and a cloud server in communication with the first and second vehicle control modules via the wireless interfaces. The first vehicle control module is configured to obtain sensor data from the multiple sensors, and transmit at least a portion of the sensor data to the cloud server via the first wireless interface, the cloud server is configured to transmit the portion of the sensor data received from the first vehicle control module to the second vehicle control module via the second wireless interface, and the second vehicle control module is configured to process the portion of the sensor data received from the cloud server to execute a collaborative vehicle processing task.

### CROSS-REFERENCE TO RELATED APPLICATIONS

This application claims the benefit of Chinese Patent Application No. 202510182241.0, filed on February 18, 2025. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure generally relates to dynamic resource allocation for connected vehicles, including collaborative tasks among connected vehicles in different regions.

Many connectivity-based vehicle collaborative tasks (such as federate learning, collaborative sensing, distributed training, etc.) require that the data source from a connected vehicle meets the feature of independent and identically distributed (IID) data. At the same time, computing resources and storage resources have to work together for better performance and improved accuracy of the tasks. However, resources of vehicles are not evenly distributed across different regions, such as busy areas, suburban areas, highways, etc. Lots of captured sensing data may only be useful for the tasks that are common to a corresponding region.

### SUMMARY

An example dynamic resource allocation system for vehicles includes a first vehicle located in a first geographic region, the first vehicle including a first vehicle control module, a first wireless interface and multiple sensors, a second vehicle located in a second geographic region different than the first geographic region, the second vehicle including a second vehicle control module and a second wireless interface, and a cloud server in communication with the first vehicle control module via the first wireless interface and the second vehicle control module via the second wireless interface; wherein the first vehicle control module is configured to obtain sensor data from the multiple sensors, and transmit at least a portion of the sensor data to the cloud server via the first wireless interface, the cloud server is configured to transmit the portion of the sensor data received from the first vehicle control module to the second vehicle control module via the second wireless interface, and the second vehicle control module is configured to process the portion of the sensor data received from the cloud server to execute a collaborative vehicle processing task.

In some examples, the collaborative vehicle processing task includes at least one task associated with an advanced driver assistance system (ADAS) control of the first vehicle or the second vehicle.

In some examples, the second vehicle control module is configured to control at least one of automated acceleration of the second vehicle, automated braking of the second vehicle, or automated steering of the second vehicle, based on the collaborative vehicle processing task.

In some examples, the first vehicle control module is configured to control at least one of automated acceleration of the first vehicle, automated braking of the first vehicle, or automated steering of the first vehicle, based on the sensor data.

In some examples, the second vehicle control module is configured to generate output data based on execution of the collaborative vehicle processing task, and transmit the output data from the collaborative vehicle processing task to the cloud server via the second wireless interface.

In some examples, the cloud server is configured to combine the output data received from the second vehicle control module with the sensor data received from the first vehicle control module to generate fused data, and transmit the fused data to the first vehicle control module via the first wireless interface.

In some examples, the collaborative vehicle processing task includes at least one of a navigation map generation task, a navigation mask update task, a local collaborative sensing task, a federated learning task, or a machine learning model learning task.

In some examples, the cloud server is configured to assign processing resources of the first vehicle control module or the second vehicle control module according to a graph-based resource network, each of the first vehicle and the second vehicle is represented as a different node of the graph-based resource network, and resource requirements of the collaborative vehicle processing task are represented as edges of the graph-based resource network.

In some examples, the cloud server is configured to assign processing resources of the first vehicle control module or the second vehicle control module to satisfy an independent and identically distributed (IID) criteria of data processed by at least one of the first vehicle control module or the second vehicle control module.

In some examples, a traffic volume in the first geographic region is greater than a traffic volume in the second geographic region.

In some examples, the first vehicle control module is configured to determine whether processing resources of the first vehicle control module are sufficient to successfully complete the collaborative vehicle processing task using the first vehicle control module, and transmit at least one of a resource request and a task announcement to the cloud server in response to determining that processing resources of the first vehicle control module are sufficient to successfully complete the collaborative vehicle processing task.

In some examples, the system includes a third vehicle located in a third geographic region different than the first geographic region and the second geographic region, the third vehicle including a third vehicle control module and a third wireless interface, wherein the third vehicle control module is configured to obtain traffic information and event information in the third geographic region, and transmit the traffic information and event information to the cloud server via the third wireless interface, to combine with the sensor data from the first vehicle control module via data fusion.

An example method of executing dynamic resource allocation for vehicles includes obtaining sensor data via multiple sensors of a first vehicle in a first geographic region, transmitting, by a first vehicle control module of the first vehicle, at least a portion of the sensor data to a cloud server via a first wireless interface of the first vehicle, transmitting, by the cloud server, the portion of the sensor data received from the first vehicle control module to a second vehicle control module of a second vehicle via a second wireless interface of the second vehicle, the second vehicle located in a second geographic region different than the first geographic region of the first vehicle, and processing, by the second vehicle control module, the portion of the sensor data received from the cloud server to execute a collaborative vehicle processing task.

In some examples, the collaborative vehicle processing task includes at least one task associated with an advanced driver assistance system (ADAS) control of the first vehicle or the second vehicle.

In some examples, the method includes controlling, by the second vehicle control module, at least one of automated acceleration of the second vehicle, automated braking of the second vehicle, or automated steering of the second vehicle, based on the collaborative vehicle processing task.

In some examples, the method includes controlling, by the first vehicle control module, at least one of automated acceleration of the first vehicle, automated braking of the first vehicle, or automated steering of the first vehicle, based on the sensor data.

In some examples, the method includes generating, by the second vehicle control module, output data based on execution of the collaborative vehicle processing task, and transmitting the output data from the collaborative vehicle processing task to the cloud server via the second wireless interface.

In some examples, the method includes combining, by the cloud server, the output data received from the second vehicle control module with the sensor data received from the first vehicle control module to generate fused data, and transmitting the fused data to the first vehicle control module via the first wireless interface.

In some examples, the collaborative vehicle processing task includes at least one of a navigation map generation task, a navigation mask update task, a local collaborative sensing task, a federated learning task, or a machine learning model learning task.

A method of executing dynamic resource allocation for vehicles includes obtaining sensor data via multiple sensors of a first vehicle in a first geographic region, transmitting, by a first vehicle control module of the first vehicle, at least a portion of the sensor data to a cloud server via a first wireless interface of the first vehicle, transmitting, by the cloud server, the portion of the sensor data received from the first vehicle control module to a second vehicle control module of a second vehicle via a second wireless interface of the second vehicle, the second vehicle located in a second geographic region, wherein a traffic volume in the first geographic region is greater than a traffic volume in the second geographic region, and processing, by the second vehicle control module, the portion of the sensor data received from the cloud server to execute a collaborative vehicle processing task.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a diagram of an example vehicle including a vehicle control module for dynamic resource allocation.

FIG. 2 is a block diagram of an example system for implementing dynamic resource allocation for connected vehicles.

FIG. 3 is a block diagram illustrating example process flows for resource optimization in the system of FIG. 2.

FIG. 4 is a flowchart depicting an example process for executing resource optimization in the system of FIG. 2.

FIG. 5 is a block diagram illustrating example process flows for collaborative tasks in the system of FIG. 2.

FIG. 6 is a flowchart depicting an example process for executing a collaborative task in the system of FIG. 2.

In the drawings, reference numbers may be reused to identify similar and/or identical elements.

### DETAILED DESCRIPTION

Some example embodiments may include systems configured to evenly distribute and allocate vehicle resources according to the complexity of regions where the vehicles are located, such as different geographic regions having different driving conditions and road traffic parameters. Example systems may dynamically handle requests for computing and storage resources based on different requirements of connectivity enabled collaborative tasks, such as collaborative sensing sharing, federate learning, data distribution and distributed training via large language models, etc. Meanwhile, example systems may also optimize the resource allocation in order to enhance data privacy and to attempt to achieve an independent and identically distributed (IID) feature for data sources that is required or desired for vehicle connectivity-based tasks.

Some example embodiments may dynamically distribute the computing and storage resources using a resource management mechanism, which may include an optimization algorithm. Different computing and storage resources may be dispatched and cross-referenced among the vehicles from different geographic regions. Geographic regions may refer to any suitable areas, such as cities, rural, suburbs, highways, various levels of street congestion and non-congestion, different types of roads and traffic, etc. In some examples, different geographic regions may be located in a same city, county, state, etc., and may at least partially overlap with one another.

Contributed data from different traffic entities may be exchanged and carefully processed based on requirements of dedicated tasks executed in different regions. Some example embodiments may avoid the data privacy issues, and achieve a target data feature of independent and identically distributed (IID) data extraction, which is important for avoiding bias in collaborative tasks.

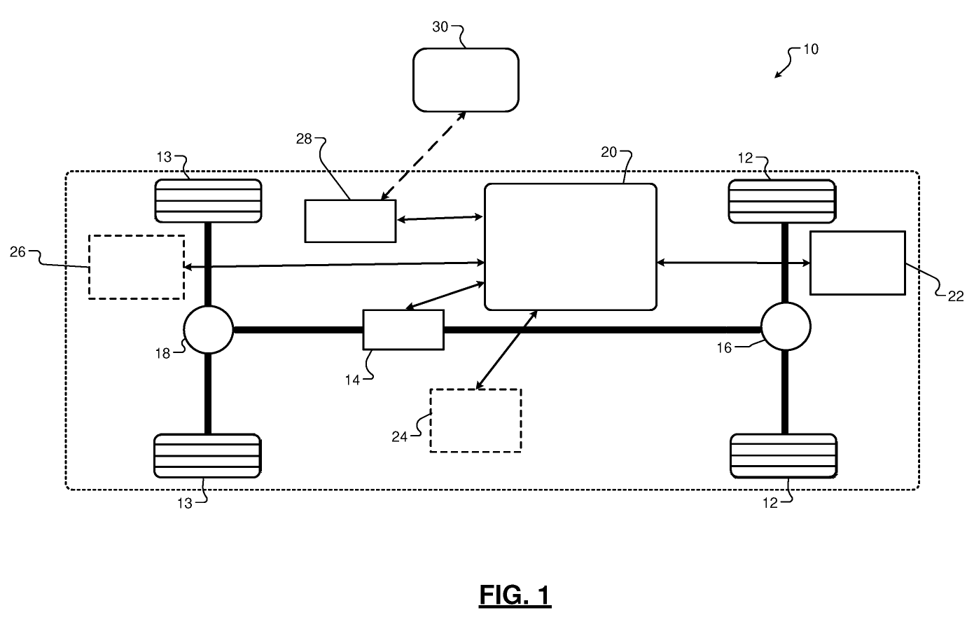

Referring now to FIG. 1, a vehicle 10 includes front wheels 12 and rear wheels 13. In FIG. 1, a drive unit 14 selectively outputs torque to the front wheels 12 and/or the rear wheels 13 via drive lines 16, 18, respectively. The vehicle 10 may include different types of drive units. For example, the vehicle may be an electric vehicle such as a battery electric vehicle (BEV), a hybrid vehicle, or a fuel cell vehicle, a vehicle including an internal combustion engine (ICE), or other type of vehicle.

Some examples of the drive unit 14 may include any suitable electric motor, a power inverter, and a motor controller configured to control power switches within the power inverter to adjust the motor speed and torque during propulsion and/or regeneration. A battery system provides power to or receives power from the electric motor of the drive unit 14 via the power inverter during propulsion or regeneration.

While the vehicle 10 includes one drive unit 14 in FIG. 1, the vehicle 10 may have other configurations. For example, two separate drive units may drive the front wheels 12 and the rear wheels 13, one or more individual drive units may drive individual wheels, etc. As can be appreciated, other vehicle configurations and/or drive units can be used.

The vehicle control module 20 may be configured to control operation of one or more vehicle components, such as the drive unit 14 (e.g., by commanding torque settings of an electric motor of the drive unit 14). The vehicle control module 20 may receive inputs for controlling components of the vehicle, such as signals received from a steering wheel, an acceleration pedal, a brake pedal, etc. The vehicle control module 20 may monitor telematics of the vehicle for safety purposes, such as vehicle speed, vehicle location, vehicle braking and acceleration, etc.

The vehicle control module 20 may receive signals from any suitable components for monitoring one or more aspects of the vehicle, including one or more vehicle sensors (such as cameras, microphones, pressure sensors, steering wheel position sensors, braking sensors, location sensors such as global positioning system (GPS) antennas, wheel height and/or position sensors, accelerometers, etc.). Some sensors may be configured to monitor current motion of the vehicle, acceleration of the vehicle, braking of the vehicle, current steering direction of the vehicle, current height and/or position of one or more wheels, etc.

In the example of FIG. 1, the vehicle 10 includes a front vehicle camera 22, an optional side vehicle camera 24, and an optional rear vehicle camera 26. Each camera may include any suitable camera hardware components, image processing capabilities, etc., to capture images of surroundings of the vehicle, such as road features, other vehicles, etc. In some examples, images from vehicle cameras may be used for object detection, automated driving, lane determination, etc. Other example embodiments may include more or less cameras, or cameras at other positions on the vehicle 10. Other systems such as Lidar may be used to determine images or information about the surrounding environment of the vehicle.

The vehicle control module 20 may communicate with another device via a wireless communication interface 28, which may include one or more wireless antennas for transmitting and/or receiving wireless communication signals. For example, the wireless communication interface 28 may communicate via any suitable wireless communication protocols, including but not limited to vehicle-to-everything (V2X) communication, Wi-Fi communication, wireless area network (WAN) communication, cellular communication, personal area network (PAN) communication, short-range wireless communication (e.g., Bluetooth), etc. The wireless communication interface 28 may communicate with a remote computing device over one or more wireless and/or wired networks. Regarding the vehicle-to-vehicle (V2X) communication, the vehicle 10 may include one or more V2X transceivers (e.g., V2X signal transmission and/or reception antennas).

As shown in FIG. 1, the wireless communication interface 28 is configured to communicate with a resource allocation module 30. As explained further below, different vehicles in different regions may have resources allocated to perform connectivity-based collaborative tasks. For example, a vehicle in one region may transmit sensor data for processing by a vehicle from another region, or for processing along with data captured by a vehicle in another region.

In some examples, results from connectivity-based collaborative tasks, dynamic resource allocation, etc., may be used by the vehicle control module 20 to automatically control acceleration of the vehicle 10 (e.g., via an accelerator or controlling a motor of the drive unit 14 to provide more power to the front wheels 12 and the rear wheels 13), to control braking of the vehicle 10 (e.g., via brakes applied to the front wheels 12 and the rear wheels 13 or via engine breaking at a motor of the drive unit 14), to control automated steering of the vehicle 10 (e.g., by rotating a steering mechanism or directly changing an orientation of the front wheels 12), etc.

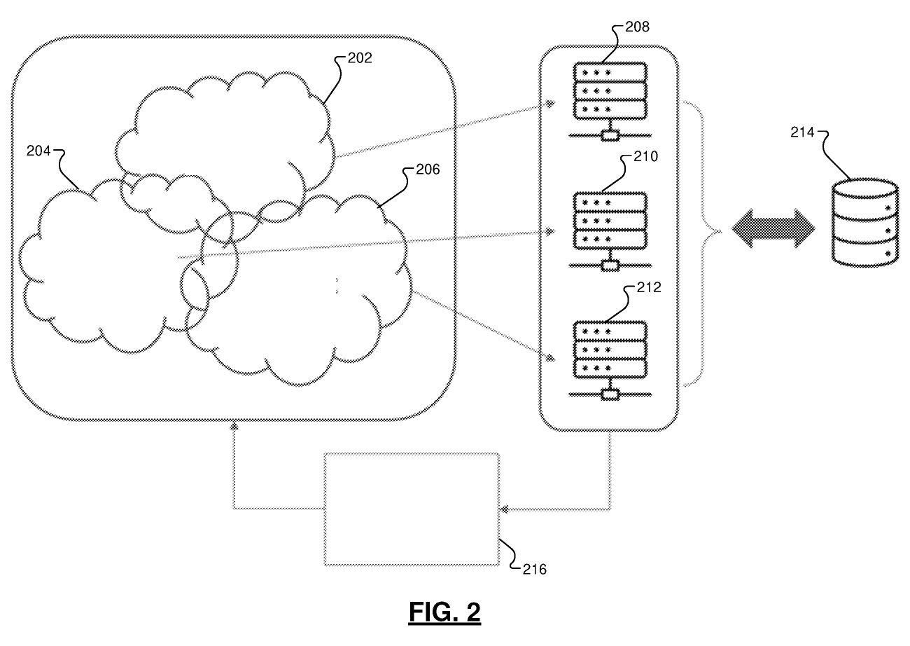

FIG. 2 is a block diagram of an example system for implementing dynamic resource allocation for connected vehicles. As shown in FIG. 2, vehicles may be located in different geographic areas, such as busy cities with lots of traffic and buildings, highway regions with lots of cars but less pedestrians and intersections, rural locations with less traffic and buildings, etc.

Vehicles in Area A (e.g., a busy city) may be configured to transmit data 202 to a server 208 which facilitates data transfer from those vehicles for dynamic resource allocation. For example, vehicles in Area A may transmit data via wireless vehicle connectivity interfaces.

Vehicles in Area B (e.g., a highway region) may be configured to transmit data 204 to a server 210 which facilitates data transfer to and from those vehicles in Area B for dynamic resource allocation. Vehicles in Area C (e.g., a rural region) may be configured to transmit data 206 to a server 212 which facilitates data transfer to and from those vehicles in Area C for dynamic resource allocation.

Each of the servers 208, 210 and 212 may be part of a same or different cloud network, may store data in a same or different database 214, etc. The database 214 may be configured to implement dynamic resource allocation 216, by managing how data and collaborative tasks are balanced among vehicles from the different geographic areas.

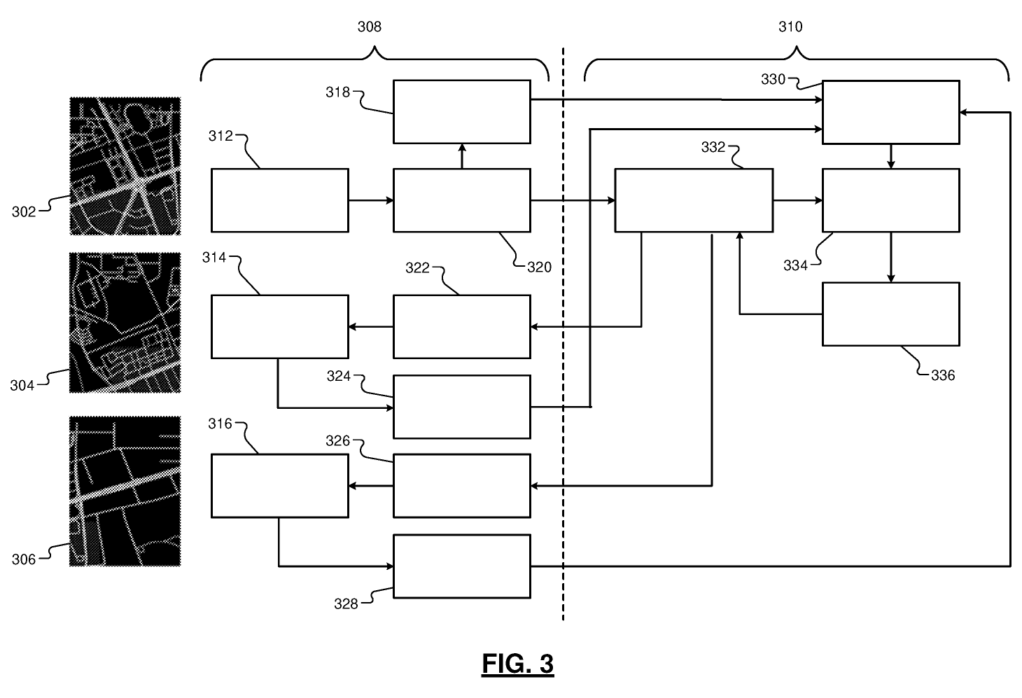

FIG. 3 is a block diagram illustrating example process flows for resource optimization in the system of FIG. 2. In the example of FIG. 3, different vehicles are located in different geographic regions, such as region 302 (Area A), region 304 (Area B), and region 306 (Area C). For example, region 302 may represent a busy urban area with lots of traffic, pedestrians, intersections, buildings, roads, other vehicles, etc. Region 304 may represent a suburban area with less congestion that region 302, but still including traffic lights, some other vehicles, some buildings, etc.

Region 306 may represent a rural area with much less traffic, less vehicles, less pedestrians, less roads and intersections, etc. In some examples, the regions 304 or 306 may include highways or other roads that allow vehicles to reach higher speeds than the more congested roads of the region 302.

The left side of FIG. 3 illustrates example actions of vehicle systems 308, and the right side of FIG. 3 illustrates example actions of a cloud system 310. For example, each vehicle may perform a task initialization, which may be the same or different for each region. Vehicle control modules of vehicles in region 302 may execute a task initialization 312, vehicle control modules of vehicles in region 304 may execute a task initialization 314, and vehicle control modules of vehicles in region 306 may execute a task initialization 316. Example task may include, but are not limited to, advance driver assistance system (ADAS) calculations for automated vehicle control, map generation for navigation, map updates, local collaborative sensing, federate learning, model learning/inferencing, etc.

In some examples, vehicles in region 302 may not have enough resources to process all collaborative tasks, due to high resource demands to track traffic, navigation, objects, etc., in the busy streets of region 302. The vehicles in region 302 may transmit a task announcement 320 that they need more resources, and a resource request 318 may be generated in response.

The resource request 318 may be transmitted to a resource management module 330 of the cloud system 310 to handle resource allocation. For example, the resource request 318 may indicated that a vehicle in region 302 is requesting tasks processing assistance from vehicles in the regions 304 or 306 which have a lower resource demand due to their less busy areas.

The resource management module 330 may be configured to reserve a resource from one or more vehicles in region 306, via a resource reservation 328. For example, the resource management module 330 may transmit data acquired by sensors of vehicles in region 302, to vehicles in region 306 for processing of the sensor data (e.g., because the vehicles in region 306 have more processing resources available compared to the vehicles in the busier region 302).

In some examples, the resource management module 330 may execute incremental learning 334, such as by training a model to implement resource optimization 336. The resource optimization 336 may be supplied to a resource network 332, such as a graph based resource network.

The resource network 332 may be configured to send task collaboration instructions to vehicles in different regions. For example, in response to receiving a task announcement 320 from a vehicle in region 302, the resource network 332 may send task collaboration instructions 322 to vehicles in region 304, and task collaboration instructions 326 to vehicles in region 306, to assist with processing data from the vehicles in region 302.

In some examples, vehicles in a region may be configured to directly transmit a dedicated resource request to the resource management module 330, without first making a task announcement. For example, FIG. 3 illustrates vehicles in the region 304 transmitting a dedicated resource request 324 directly to the resource management module 330.

In some examples, resource optimization may focus on generating the mechanism of resource management and incremental learning, based on dynamic situations from the vehicles located in the different regions. For example, FIG. 3 illustrates example connected tasks which may require resources across three typical regions, including Area A (region 302), which may be a very busy area where vehicles are mainly focusing on obstacle recognition, and planning related distributed learning. Area B (region 304, may be a common road with key traffic information and data related to events occurring, which may heavily influence the traffic of Area A (region 302) and Area C (region 306), etc. Area C (region 306), may be an area with small roads, and heavy traffic may not commonly happen in this area (such as a rural community area).

Vehicles entering into different areas may normally be prone to start dedicated tasks that are especially useful within those different areas. Meanwhile, background modules may also try to capture data located in the vehicle’s current area for developing a better understanding of the situation according to the requirement of different tasks (e.g., collaborative sensing). Because of that, captured data in all the areas may introduce bias, and lose the attribute of independent and identically distributed (IID) data.

In some examples, vehicles located in the area A may consistently lack processing resources to handle tons of data, which may lead to an incorrect route planning result and worse traffic efficiency. On the other hand, key information from Area B (such as event and traffic information), may not be directly achieved, accessed or determined by vehicles in Area A.

Some example embodiments herein, such as the system of FIG. 3, may include a resource management system to address the above issues. At the beginning (or periodically, etc.), vehicles in different areas may be configured to initialize tasks (e.g., via a tasks initialization module 312) with necessary parameters and requirements for exchanging data.

In the Area A (region 302 in FIG. 3), since vehicles are consistently lacking resources to handle current processing tasks, a task announcement module 320 may be used to notify the backend service that resources for a dedicated task are required in order to mitigate the pressure of computing. Vehicles in this area may also convey a resource request 318 to the resource management module 330 in the backend service to check any other resources can be used to collaborating to complete the task they would like to complete.

A graph-based resource network module 332 may be used to indicate and connect the different vehicles (e.g., nodes) and resources requirements (e.g., edges) in the graph data structure. The graph-based resource network module 332 may be configured to ask the task vehicles in different areas to launch a tasks collaboration module 322 to decide which vehicles could help to handle the specific task.

In area B (region 304), since key information about traffic lights and traffic events may be important for a collaborative task started by vehicles in area A, information may be provided to vehicles in area A to achieve better accuracy for a task goal. However, the vehicles in area A may not have enough space to store the information, and recognized data may not be stored in the cloud site due to data privacy and data compliance polices. A Dedicated Resource Request 324 may be sent to the backend for handing the special event in the backend, or in vehicles in another area. A backend service may receive this requirement and feed forward to the resource optimization 336 for further processing.

In area C (region 306), since the vehicles may have more resources and idle for processing different tasks, once vehicles receive the tasks collaboration request 326 from the backend (e.g., the cloud system 310), vehicles may allocate reserved resources that are ready to be used to handle tasks from other areas. A vehicle control module of a vehicle in region 306 may notify the resource management module 330 in the backend side (e.g., the cloud system 310) that resources may be used for collaboration.

On the other hand, the resource management module 330 in the cloud site may receive the request of resource allocation and free resources. The resource management module 330 may be configured to train a model targeting to optimize the most efficient resource usage, which is less data exchange consuming. The resource optimization 336 may optimize the ratio of resources allocated for a dedicated task, and exchange data across different regions.

In other words, computing and storage resources may be dispatched and cross-referenced among the vehicles from different regions. The contribution data from different traffic entities can be exchanged and carefully processed (e.g., feature based only by encoded data), based on the requirements of the dedicated tasks. The system may also avoid data privacy issues, since only processed and encoded features may be exchanged and uploaded via cloud based computing modules in some examples. The result of a Resources Optimization model may modify the graph based resource network 332 with optimized resources (e.g., via weights on edges) to guide the data exchange and resource allocation in the vehicle site.

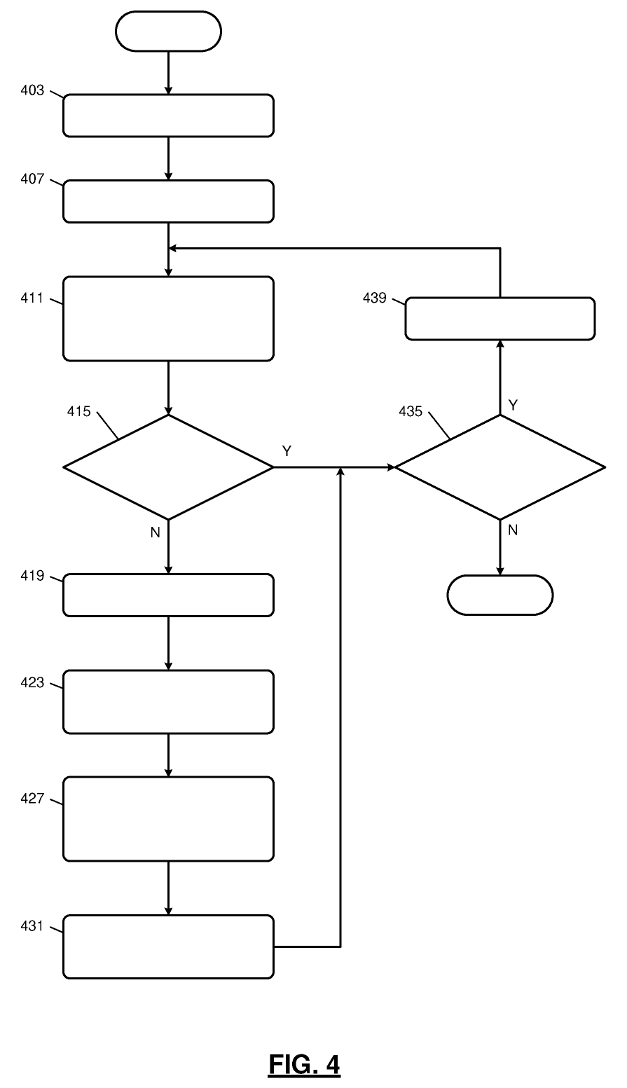

FIG. 4 is a flowchart depicting an example process for executing resource optimization in the system of FIG. 2. The process of FIG. 4 may be implemented by one or more of the vehicle control module 20 of FIG. 1, and the vehicle systems 308 and cloud system 310 of FIG. 3.

At 403, the process begins by initializing tasks at vehicles in different regions. Control then selects a first one of the multiple regions each having different vehicles, at 407. At 411, control determines whether vehicles in the selected region have sufficient processing or storage resources for a task.

If the vehicles in the selected region do not have sufficient resources for the task at 415, control proceeds to 419 to transmit a task announcement to a backend service (e.g., a cloud system). Control then conveys a resource request to a resource management module at 423.

At 427, control connects different vehicles in different regions using a graph-based resource network, where different vehicles may be represented by nodes and different resource requirements may be represented by edges. At 431, control processes data in vehicles from regions other than where the data originated, using collaboration task requests.

If the resources are determined to be sufficient for vehicles in the region at 415, control proceeds to 435 to determine whether any regions are remaining to be checked. If so, control proceeds to 439 to select a next region, and returns to 411 to determine whether vehicles in the next selected region have sufficient resources for the task.

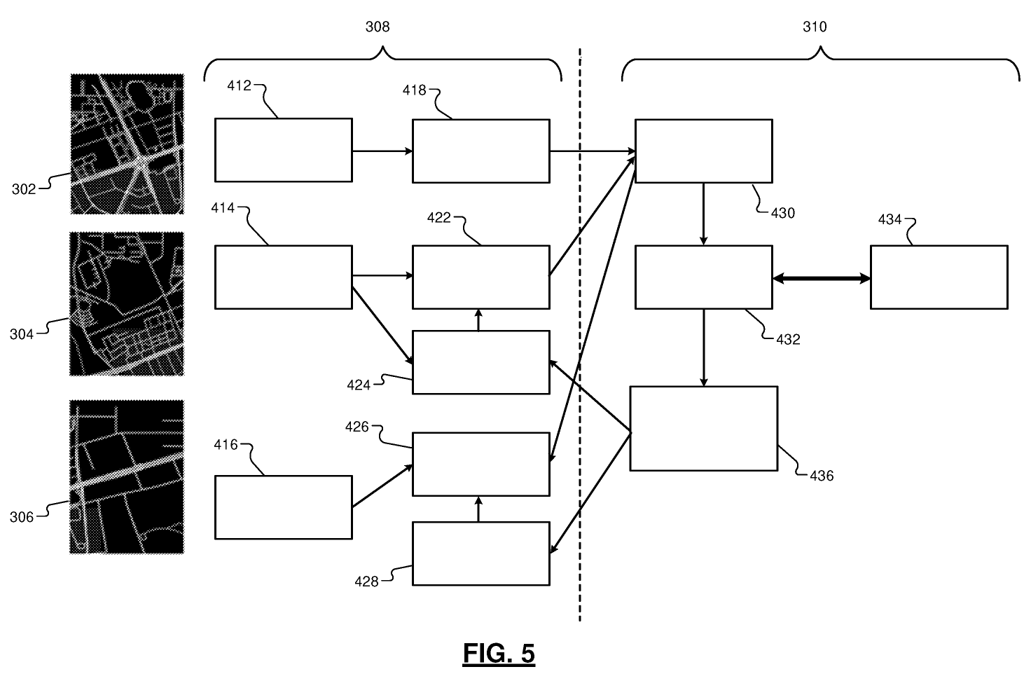

FIG. 5 is a block diagram illustrating example process flows for collaborative tasks in the system of FIG. 2. As shown in the example of FIG. 1, vehicles in region 302 (Area A) may be configured to implement part one of collaborative execution tasks 412, by transmitting key data contributions 418 to a cloud system 310.

For example, vehicles in region 302 may acquire data from sensors, but not have processing resources adequate to fully process all of the sensor data. The vehicle control modules may transmit the key data contributions 418 to the cloud system 310, where data fusion 430 occurs for the sensor feature data.

Vehicles in region 304 may be configured to implement part two of collaborative tasks execution 414, by transmitting dedicated data contributions 422 to the cloud system 310. For example, vehicles in region 304 may obtain traffic information, etc., and transmit that data to the cloud system 310 to be combined with data from other vehicles in other regions via data fusion 430.

In some examples, the vehicles in region 304 may use dedicated resource leverage 424 to control the dedicated data contribution 422. The dedicated resource leverage 424 may be modified by the resource management module 436, to provide optimized resource allocation.

Vehicles in the region 306 may implement part three of collaborative tasks execution 416, by processing key data contributions 426 based on data from region 306, and data obtained from vehicles in another region such as region 302. For example, the data fusion 430 from the cloud system 310 may transmit data obtained from vehicles in region 302 to vehicles in region 306 for processing.

In some examples, the vehicles in region 306 may use computing resource leverage 428 to control the key data contribution 426. The computing resource leverage 428 may be modified by the resource management module 436, to provide optimized resource allocation.

The data fusion 430 may be used for implementing multiple collaborative computing tasks, such as a first collaborative computing task 432 through an Nth collaborative computing task 434. Outputs from the collaborative computing tasks may be supplied to the resource management module 436, to provide optimized resource allocation.

In some examples, collaborative task implementation may include data exchange and collaboration once resources of different vehicles are optimized and allocated, according to the guidance of the resource network and resource management module from backend site (e.g., the cloud system 310). In an example, a connected collaborative task is implemented to enhance traffic efficiency in a large area covering Area A (region 302), Area B (region 304) and Area C (region 306. The collaborative tasks execution may be separated into three parts (or more or less in other example embodiments).

Area A (region 302) may be considered as the master area to lead and launch this task. Since the resources of vehicles in region 302 may not be sufficient to handle lots of streaming sensing data, vehicles in region 302 may need to send the Key data (e.g., feature data which avoids issues with data privacy) to the backend site (such as a Key Data Contribution module) for further processing. The cloud system 310 may be aware of the resource allocation strategy, so the Data fusion 430 will wait to receive necessary data from other areas before allocating data to vehicles in other regions for processing.

Vehicles in Area B (region 304) may obtain key information that other areas do not have. For example, vehicles in region 306 may contribute dedicated data including the traffic information and event information to the data fusion module 430 in the backend for further collaboration processing.

However, vehicles in region 304 may not have sufficient storage to store multiple dynamic events, and may require external resources to help. In this example, the resource management optimized resources module 436 may indicated that vehicles in the area C can help. Once the vehicle in area C receives the request from the backend, it may use a point 2 point (V2V) direct connection for communicating with vehicles in Area B, and store the information as a database for quick further reference. The data may be stored dynamically, and may not be stored in the cloud site due to data privacy and data compliance policies).

Vehicles in Area C (region 306), on the other hand, may have enough computing and storage resources to release processing pressure for vehicles in other regions. Vehicles in region 306 may first use the computing resource leverage module 428 to gather requests from different regions.

An example use case is storage resource usage, as described above. Another example use case is collaborative data processing where raw data is captured from Area A. This processing may be important to help to evenly distribute the data and make the data independent and identically distributed with local classification. Local sub training steps may be used to extract the identically distributed features, which could be sent to the backend for further processing and to get better accuracy without introducing bias to reduce the overfitting.

In some examples, the collaborative computing for this dedicated task in the backend site (e.g., the cloud system 310) gathers all the information from data fusion module 430, at the same time, and it also notifies the Resources management module 436 that the related resources can be updated and to get ready for the next cycle of data fusion and processing. In this example, the relationship between the nodes with edge (resources requirement) may be changed, because some sub tasks are completed and no longer need resources from different regions.

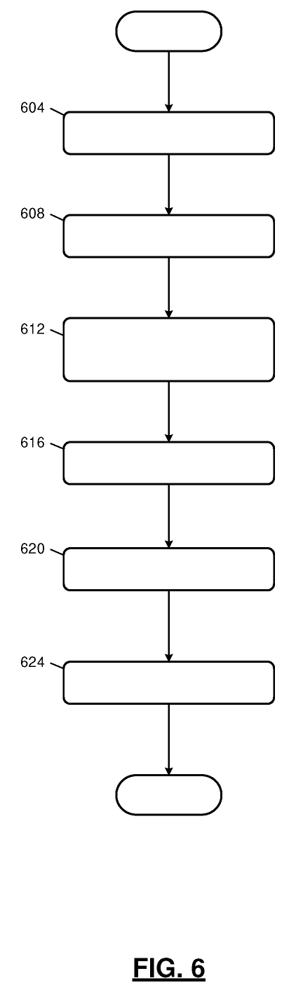

FIG. 6 is a flowchart depicting an example process for executing a collaborative task in the system of FIG. 2. The process of FIG. 6 may be implemented by one or more of the vehicle control module 20 of FIG. 1, and the vehicle systems 308 and cloud system 310 of FIG. 3.

At 604, the process begins by obtaining sensor data from vehicles in a first geographic region (such as a busy city area). At 608, control transmits key data including the sensor data, to a back end site. For example, only the key data may be sent to avoid data privacy issues.

At 612, control obtains dedicated data from vehicles in second geographic region different from the first region. The dedicated data may include traffic information and event information, for example. Control then transmits the dedicated data to the backend site at 616.

At 620, control transmits the gathered data from the backend site to vehicles in a third geographic region different than the first and second geographic regions. The vehicles in the third geographic regions then process the data, and return the data to the backend site at 624 for data fusion.

Some example embodiments may provide one or more benefits to dynamic resource allocation for connected vehicles, including but not limited to, maximizing leveraging of vehicle leveraging for better performance on tasks of connected vehicles in an efficient way. The tasks may include any suitable category and domain, such as ADAS, Federated learning etc.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A dynamic resource allocation system for vehicles, the system comprising:
a first vehicle located in a first geographic region, the first vehicle including a first vehicle control module, a first wireless interface and multiple sensors;
a second vehicle located in a second geographic region different than the first geographic region, the second vehicle including a second vehicle control module and a second wireless interface; and
a cloud server in communication with the first vehicle control module via the first wireless interface and the second vehicle control module via the second wireless interface; wherein:
the first vehicle control module is configured to obtain sensor data from the multiple sensors, and transmit at least a portion of the sensor data to the cloud server via the first wireless interface;
the cloud server is configured to transmit the portion of the sensor data received from the first vehicle control module to the second vehicle control module via the second wireless interface; and
the second vehicle control module is configured to process the portion of the sensor data received from the cloud server to execute a collaborative vehicle processing task.

2. The system of claim 1, wherein the collaborative vehicle processing task includes at least one task associated with an advanced driver assistance system (ADAS) control of the first vehicle or the second vehicle.

3. The system of claim 2, wherein the second vehicle control module is configured to control at least one of automated acceleration of the second vehicle, automated braking of the second vehicle, or automated steering of the second vehicle, based on the collaborative vehicle processing task.

4. The system of claim 2, wherein the first vehicle control module is configured to control at least one of automated acceleration of the first vehicle, automated braking of the first vehicle, or automated steering of the first vehicle, based on the sensor data.

5. The system of claim 1, wherein the second vehicle control module is configured to:
generate output data based on execution of the collaborative vehicle processing task; and
transmit the output data from the collaborative vehicle processing task to the cloud server via the second wireless interface.

6. The system of claim 5, wherein the cloud server is configured to:
combine the output data received from the second vehicle control module with the sensor data received from the first vehicle control module to generate fused data; and
transmit the fused data to the first vehicle control module via the first wireless interface.

7. The system of claim 1, wherein the collaborative vehicle processing task includes at least one of a navigation map generation task, a navigation mask update task, a local collaborative sensing task, a federated learning task, or a machine learning model learning task.

8. The system of claim 1, wherein:
the cloud server is configured to assign processing resources of the first vehicle control module or the second vehicle control module according to a graph-based resource network;
each of the first vehicle and the second vehicle is represented as a different node of the graph-based resource network; and
resource requirements of the collaborative vehicle processing task are represented as edges of the graph-based resource network.

9. The system of claim 8, wherein the cloud server is configured to assign processing resources of the first vehicle control module or the second vehicle control module to satisfy an independent and identically distributed (IID) criteria of data processed by at least one of the first vehicle control module or the second vehicle control module.

10. The system of claim 1, wherein a traffic volume in the first geographic region is greater than a traffic volume in the second geographic region.

11. The system of claim 1, wherein the first vehicle control module is configured to:
determine whether processing resources of the first vehicle control module are sufficient to successfully complete the collaborative vehicle processing task using the first vehicle control module; and
transmit at least one of a resource request and a task announcement to the cloud server in response to determining that processing resources of the first vehicle control module are sufficient to successfully complete the collaborative vehicle processing task.

12. The system of claim 1, further comprising a third vehicle located in a third geographic region different than the first geographic region and the second geographic region, the third vehicle including a third vehicle control module and a third wireless interface, wherein the third vehicle control module is configured to:
obtain traffic information and event information in the third geographic region; and
transmit the traffic information and event information to the cloud server via the third wireless interface, to combine with the sensor data from the first vehicle control module via data fusion.

13. A method of executing dynamic resource allocation for vehicles, the method comprising:
obtaining sensor data via multiple sensors of a first vehicle in a first geographic region;
transmitting, by a first vehicle control module of the first vehicle, at least a portion of the sensor data to a cloud server via a first wireless interface of the first vehicle;
transmitting, by the cloud server, the portion of the sensor data received from the first vehicle control module to a second vehicle control module of a second vehicle via a second wireless interface of the second vehicle, the second vehicle located in a second geographic region different than the first geographic region of the first vehicle; and
processing, by the second vehicle control module, the portion of the sensor data received from the cloud server to execute a collaborative vehicle processing task.

14. The method of claim 13, wherein the collaborative vehicle processing task includes at least one task associated with an advanced driver assistance system (ADAS) control of the first vehicle or the second vehicle.

15. The method of claim 14, further comprising controlling, by the second vehicle control module, at least one of automated acceleration of the second vehicle, automated braking of the second vehicle, or automated steering of the second vehicle, based on the collaborative vehicle processing task.

16. The method of claim 14, further comprising controlling, by the first vehicle control module, at least one of automated acceleration of the first vehicle, automated braking of the first vehicle, or automated steering of the first vehicle, based on the sensor data.

17. The method of claim 13, further comprising:
generating, by the second vehicle control module, output data based on execution of the collaborative vehicle processing task; and
transmitting the output data from the collaborative vehicle processing task to the cloud server via the second wireless interface.

18. The method of claim 17, further comprising:
combining, by the cloud server, the output data received from the second vehicle control module with the sensor data received from the first vehicle control module to generate fused data; and
transmitting the fused data to the first vehicle control module via the first wireless interface.

19. The method of claim 13, wherein the collaborative vehicle processing task includes at least one of a navigation map generation task, a navigation mask update task, a local collaborative sensing task, a federated learning task, or a machine learning model learning task.

20. A method of executing dynamic resource allocation for vehicles, the method comprising:
obtaining sensor data via multiple sensors of a first vehicle in a first geographic region;
transmitting, by a first vehicle control module of the first vehicle, at least a portion of the sensor data to a cloud server via a first wireless interface of the first vehicle;
transmitting, by the cloud server, the portion of the sensor data received from the first vehicle control module to a second vehicle control module of a second vehicle via a second wireless interface of the second vehicle, the second vehicle located in a second geographic region, wherein a traffic volume in the first geographic region is greater than a traffic volume in the second geographic region; and
processing, by the second vehicle control module, the portion of the sensor data received from the cloud server to execute a collaborative vehicle processing task.
